(19) United States
(12) Patent Application Publication
(10) Pub. No.: US 2013/0045541 A1
(43) Pub. Date: Feb. 21, 2013

(54) OPTICAL GAS SENSOR

(71) Applicants: Richard Fix, Gerlingen (DE); Petra Neff, Stuttgart (DE)

(72) Inventors: Richard Fix, Gerlingen (DE); Petra Neff, Stuttgart (DE)

(21) Appl. No.: 13/576,438

(22) PCT Filed: Dec. 20, 2010
(86) PCT No.: PCT/EP2010/070265

§ 371 Date: Oct. 18, 2012

(30) Foreign Application Priority Data
Feb. 1, 2010 (DE) 10 2010 001 443.5

(51) Int. Cl. G01N 21/75

(52) U.S. Cl. 436/164; 422/83

(57) ABSTRACT

A gas sensor and method for ascertaining the concentration of one or more gas species, in the exhaust gas of an internal combustion engine. The gas sensor includes a measuring cell having a gas inlet, a gas outlet, a catalysis area, and an analysis area. The sensor also includes a catalytic converter for catalyzing a reaction of a first gas species to form a second gas species in the catalysis area, and a gas analyzer for spectroscopically measuring the concentration of the second gas species in the analysis area. Through the catalytic converter, a first gas species may be converted into a second gas species whose absorption and/or scattering wavelength(s) are within the emission wavelength range of semiconductor radiation sources, so that the gas analyzer may have a semiconductor radiation source.

### FIELD OF THE INVENTION

The present invention relates to a gas sensor and a method for ascertaining the concentration of one or more gas species, in particular in the exhaust gas of an internal combustion engine.

### BACKGROUND INFORMATION

The purpose of the exhaust gas sensors is to detect all exhaust gas components metrologically. In addition to the oxygen content, for example, the content of nitrogen oxides (NOₓ), in particular nitrogen monoxide (NO) and nitrogen dioxide (NO₂), hydrocarbons (CₘHₙ), ammonia (NH₃), and carbon monoxide (CO) is relevant. In particular in the exhaust gas sensors, in addition to the oxygen content, the content of nitrogen monoxide, nitrogen dioxide, and ammonia is of central significance.

Nitrogen monoxide and nitrogen dioxide occur in various concentration ratios in the exhaust gas depending on the instantaneous load point of the engine, and ammonia may enter the environment from certain exhaust gas aftertreatment systems, in particular SCR systems.

Many stationary gas analysis systems for laboratory applications are based on the spectroscopy of certain wavelengths in the ultraviolet, visible, and infrared ranges due to the high precision and reliability of the measurement. Since every gas molecule has characteristic absorption frequencies, in contrast to most other gas measuring methods, for example, using double-chamber sensors, which only output a summation signal of multiple gas species, such as nitrogen oxides and ammonia (“Thick Film ZrO₂ NOₓ Sensor”, N. Kato et al., Society of Automotive Engineers, (SAE paper number 960334): 137-142, 1996), a selective measurement of each gas species is possible. European Patent No. EP 1 398 485 A2 and PCT Application No. WO 2009/056709 A2 describe, for example, the spectroscopic analysis of gases.

In accordance with the gas species to be detected, a radiation source is required for this purpose, which emits photons in the characteristic absorption wavelength range of these gas molecules. While complex laboratory laser systems or other stabilized radiation sources may be used for stationary applications, simple and inexpensive radiation sources, such as semiconductor laser diodes or light-emitting diodes (LEDs), are popular for mobile sensor applications.

Radiation sources having a wavelength range of significantly less than 250 nm are required for the optical detection of numerous gas species. While the characteristic absorption wavelengths of nitrogen dioxide are in the range from ≧250 nm to ≦450 nm, wavelengths from ≧180 nm to ≦230 nm are required for detecting nitrogen monoxide and ammonia, for example.

The present state of the research is that semiconductor laser diodes may be produced only having emission wavelengths significantly above 300 nm. Laser diodes are only commercially available from approximately 380 nm. Lower wavelengths are possible with LEDs. Presently, however, only LEDs having a minimal emission wavelength of 250 nm are commercially available.

A first, more recent approach for the precise optical detection of exhaust gas components using LED-based radiation sources therefore concentrates on the gases nitrogen monoxide and sulfur dioxide (“Real-time exhaust gas sensor with high resolution for onboard sensing of harmful components”, Degner, Ewald et al., IEEE Sensors Conference 2008).

The components nitrogen monoxide and ammonia, which are important for the exhaust gas analysis and the regulation of the exhaust gas aftertreatment, are not measurable therewith, however.

### SUMMARY

An object of the present invention is to provide a gas sensor, in particular an optical or spectroscopic gas sensor, for ascertaining the concentration of one or more gas species, for example, nitrogen monoxide and nitrogen dioxide and possibly ammonia, in particular in the exhaust gas of an internal combustion engine, for example, an internal combustion engine of a motor vehicle, including
a measuring cell having a gas inlet, a gas outlet, a catalysis area, and an analysis area, the catalysis area being situated on the gas inlet side of the analysis area,
a catalytic converter for catalyzing a reaction of a first gas species to form a second gas species in the catalysis area, and
a gas analyzer for spectroscopically measuring, for example, by absorption spectroscopy, fluorescence spectroscopy, vibrational spectroscopy, and/or diffraction spectroscopy, the concentration of the second gas species in the analysis area.

“Spectroscopic” methods or measurements may be understood in particular as observation methods which study, on the basis of the electromagnetic spectrum of an electromagnetic radiation source, how electromagnetic radiation and material interact. For example, methods which are based on the absorption or emission, for example, the fluorescence, and/or the scattering or diffraction of electromagnetic radiation, for example, in the wavelength range from ≧200 nm to ≦6000 nm, are referred to as “spectroscopic.”

A first gas species, whose absorption and/or scattering wavelength(s) are outside the emission wavelength range of presently available semiconductor radiation sources, for example, nitrogen monoxide or ammonia, may be converted by the catalytic converter into a second gas species, for example, nitrogen dioxide, whose absorption and/or scattering wavelength(s) are within the emission wavelength range of presently available semiconductor radiation sources.

This advantageously allows the use of gas analyzers having simple and inexpensive semiconductor radiation sources, such as semiconductor laser diodes and light-emitting diodes (LEDs), and therefore the mobile use of the gas sensor. In addition, the sensor properties of future gas analyzers which are based on semiconductor radiation sources having emission wavelengths of less than 250 nm may possibly also be improved by this principle.

The catalytic converter may make it possible for a gas species mixture to be measured in the thermodynamic equilibrium, in particular also when otherwise no thermodynamic equilibrium would appear within the dwell time before the gas sensor.

In the case of nitrogen oxides, the catalytic converter may ensure that the thermodynamic equilibrium results between nitrogen monoxide and nitrogen dioxide in the presence of oxygen: 2 NO+O₂ [symbol] 2 NO₂.

For example, if one operates a catalytic converter at 300° C. and achieves complete conversion, a nitrogen monoxide fraction of 40 mol-% and a nitrogen dioxide fraction of 60 mol-% may be present downstream from the catalytic converter, and independently of the ratio in which these gas components were present upstream from the catalytic converter.

This has the advantage that the sum of the concentrations of the first and second gas species, for example, a NOₓ summation signal, may be measured.

The catalytic converter may be designed in particular in such a way that a first gas species is oxidized or reduced, in particular oxidized, to form a second gas species.

The catalytic converter may be an oxidation catalytic converter for the oxidation of a first gas species to form a second gas species or a reduction catalytic converter for the reduction of a first gas species to form a second gas species, for example.

Within the scope of one specific embodiment, the catalytic converter is an oxidation catalytic converter for the oxidation of a first gas species to form a second gas species.

Within the scope of another specific embodiment, the gas sensor is designed for measuring the concentration of nitrogen monoxide, the catalytic converter being an oxidation catalytic converter for the oxidation of nitrogen monoxide to form nitrogen dioxide. In other words, the catalytic converter catalyzes the oxidation reaction of nitrogen monoxide to form nitrogen dioxide. The gas sensor according to the present invention thus advantageously allows a detection of nitrogen monoxide, which is required for the exhaust gas aftertreatment and onboard diagnosis, based on presently available semiconductor radiation sources.

As the following reaction equations show, a partial conversion of ammonia to nitrogen oxides may be caused by a catalytic converter in the case of ammonia:

4 NH₃+3 O₂ [symbol] 2 N₂+6 H₂O

4 NH₃+5 O₂ [symbol] 4 NO+6 H₂O

4 NH₃+7 O₂ [symbol] 4 NO₂+6 H₂O

A possibly present ammonia concentration may be measured indirectly as a nitrogen oxide signal in this way.

Within the scope of another specific embodiment, the gas sensor is designed for measuring the concentration of ammonia, the catalytic converter being an oxidation catalytic converter for the oxidation of ammonia to form nitrogen dioxide. In other words, the catalytic converter catalyzes the oxidation reaction of ammonia to form nitrogen dioxide. A detection of ammonia, which is required for the exhaust gas aftertreatment and onboard diagnosis, based on presently available semiconductor radiation sources, may also advantageously be made possible.

Within the scope of another specific embodiment, the catalytic converter is integrated in a gas-permeable wall of the measuring cell. This has the advantage that the catalytic converter may optionally simultaneously function as a particle filter.

Within the scope of another specific embodiment, the catalytic converter is designed in the form of a coating on an inner side of the measuring cell.

Within the scope of another specific embodiment, the catalytic converter is designed in the form of a gas-permeable element which subdivides the measuring cell. In this way, the catalytic converter may decrease possibly occurring gas species eddies between the individual analysis areas.

The catalytic converter is preferably designed in such a way that the catalytic converter ensures a complete conversion at a temperature from ≧100° C. to ≦600° C., for example, from ≧200° C. to ≦400° C. The catalytic converter volume may be ascertained from the inflow volume of the gas sensor and the complete conversion temperature of the catalytic converter.

The catalytic converter may include, for example, platinum, rhodium, palladium, or a mixture thereof. For example, the catalytic converter may be platinum or a rhodium-platinum mixture or a platinum-palladium mixture. In particular, the catalytic converter may be supported on ceramic particles, for example, having an average particle size in the micrometer to nanometer range, for example, aluminum oxide and/or zirconium oxide particles.

The gas sensor may also be designed in such a way that the gas species mixture to be analyzed may be measured spectroscopically both before and also after the conversion by the catalytic converter, for example, by absorption spectroscopy, fluorescence spectroscopy, vibrational spectroscopy, and/or diffraction spectroscopy. Thus, for example, a measurement of a gas species before and after the conversion by the oxidation catalytic converter is possible.

Thus, for example, in the case of a nitrogen monoxide or ammonia gas sensor, the nitrogen dioxide concentration may be determined upstream and downstream from the oxidation catalytic converter and therefore the concentration of nitrogen monoxide or ammonia in the gas species mixture may be inferred.

Within the scope of another specific embodiment, the gas sensor includes another gas analyzer for spectroscopically measuring, for example, by absorption spectroscopy, fluorescence spectroscopy, vibrational spectroscopy, and/or diffraction spectroscopy, the concentration of the second gas species in another analysis area of the measuring cell, the other analysis area being situated on the gas inlet side of the catalysis area. More than one summation signal of first and second gas species may thus advantageously be output. This allows existing gas sensors, such as double chamber sensors, to be replaced by gas sensors according to the present invention.

The gas analyzer or analyzers may have in particular a radiation source, for example, a radiation source emitting ultraviolet and/or visible and/or infrared radiation. The radiation source is preferably designed and/or situated in such a way that radiation emitted by the radiation source is transmitted through the analysis area. Furthermore, the radiation source is preferably designed in such a way that the radiation source emits radiation in the absorption and/or scattering wavelength range of the second gas species. For example, the radiation source may emit radiation which includes one or more wavelengths of the range from ≧250 nm to ≦450 nm, in particular from ≧380 nm to ≦450 nm.

Within the scope of another specific embodiment, the gas analyzer or analyzers (each) include at least one semiconductor radiation source, in particular one or more semiconductor laser diodes (LD) and/or one or more light-emitting diodes (LED). For example, the gas analyzer or analyzers may each include one or more semiconductor laser diodes (LD) and/or one or more light-emitting diodes (LED). For example, a gas analyzer may include multiple semiconductor laser diodes or multiple light-emitting diodes having various emission wavelengths, for example, 300 nm, 400 nm, and 500 nm. Or the gas analyzer may include a semiconductor laser diode or multiple semiconductor laser diodes having various emission wavelengths and a light-emitting diode or multiple light-emitting diodes having various emission wavelengths.

Furthermore, the gas analyzer or analyzers may have a radiation detector in particular. The radiation detector is preferably designed and/or situated in such a way that the radiation detector measures the intensity of radiation transmitted by the radiation source through the analysis area. The radiation detector is preferably designed in such a way that the radiation detector measures the intensity of at least one absorption and/or scattering wavelength of the second gas species.

The radiation source preferably emits radiation having a known, constant intensity. The concentration of the second gas species may thus be inferred directly from the intensity measured by the radiation detector. Radiation having a known, constant intensity may be achieved, for example, in that a semiconductor radiation source is regulated via electronics to a constant output power.

However, it is also possible to use a radiation source which emits radiation having a varying intensity.

In this case, the radiation emitted by the radiation source may be divided, one part of the radiation being transmitted through the analysis area and another part of the radiation being transmitted through a reference area and subsequently the intensities of the radiation fractions each being measured by a radiation detector and a reference radiation detector. This may be implemented, for example, in that the gas sensor has a radiation divider for dividing the radiation emitted by the radiation source and for transmitting one radiation part into the analysis area and another radiation fraction into a reference chamber, in particular corresponding in the dimensions to the analysis area, and a reference radiation detector for measuring the intensity of at least one absorption and/or scattering wavelength of the second gas species after its transmission through the reference chamber. The intensity measured by the radiation detector may thus be scaled by the intensity measured by the reference radiation detector.

Furthermore, it is possible that the gas sensor has a reference radiation detector for measuring the intensity of at least one wavelength transmitted through the analysis area and different from the absorption and/or scattering wavelengths of the gas species mixture. The intensity measured by the radiation detector may thus be scaled by the intensity measured by the reference detector.

The gas analyzer or analyzers may also have one or more optical lenses, in particular converging lenses for bundling incident radiation. The lenses may be integrated into the wall of the measuring cell in the analysis area, for example. In this way, for example, radiation emitted by the radiation source may be transmitted bundled by the lens into the analysis area of the measuring cell. Radiation transmitted through the analysis area may also be bundled by a lens.

In addition, the gas analyzer or analyzers may have one or more radiation-conducting fibers, in particular glass fibers. These may be designed in particular for conducting radiation from the radiation source to the measuring cell, in particular to a lens integrated into the wall of the measuring cell, and/or from the measuring cell, in particular from a lens integrated into the wall of the measuring cell, to the radiation detector. In this way, the radiation source and the radiation detector may be situated in a colder area remote from the measuring cell, which has an advantageous effect on the service life of the radiation source and the radiation detector.

In particular, the gas analyzer or analyzers may include a combined radiation source-radiation detector device and a radiation reflection layer. The combined radiation source-radiation detector device may be situated on one side of the measuring cell, the measuring cell having the radiation reflection layer on the opposite side. The combined radiation source-radiation detector device and the radiation reflection layer may be situated, for example, in such a way that radiation emitted by the radiation source of the combined radiation source-radiation detector device is transmitted through the analysis area, is reflected by the radiation reflection layer, transmitted through the analysis area again, and transmitted back into the combined radiation source-radiation detector device. In this way, the intensity of a wavelength transmitted through the analysis area may advantageously be measured.

Within the scope of another specific embodiment, the gas sensor includes two or more measuring cells, the measuring cells each having a gas inlet, a gas outlet, a catalysis area, and an analysis area, the catalysis area being situated in each case on the gas inlet side of the analysis area and the gas sensor also including two or more catalytic converters for catalyzing reactions of first gas species to form second gas species in one of the catalysis areas in each case and two or more gas analyzers for spectroscopically measuring, for example, by absorption spectroscopy, fluorescence spectroscopy, vibrational spectroscopy, and/or diffraction spectroscopy, the concentration of the second gas species in one of the analysis areas in each case.

The individual measuring cells may be operated in this case at different temperatures and/or the individual gas analyzers may be operated at different wavelengths, for example. In addition, the individual catalytic converters may be different catalytic converters and may catalyze different reactions of first gas species to form second gas species.

The measuring cells may in particular be operated at different temperatures, so that similarly designed catalytic converters of different measuring cells catalyze reactions at different strengths.

Alternatively or additionally thereto, the gas analyzers may be operated at different wavelengths. Thus, different gas analyzers may measure different second gas species. For example, one gas analyzer may measure nitrogen dioxide and the other gas analyzer may measure sulfur dioxide.

Alternatively or additionally thereto, the gas sensor may have different catalytic converters. The different catalytic converters may catalyze, for example, different reactions of first gas species to form second gas species. In particular, the different catalytic converters may catalyze reactions of different first gas species to form identical second gas species or identical first gas species to form different second gas species. For example, one catalytic converter may catalyze the oxidation of nitrogen monoxide to form nitrogen dioxide and another catalytic converter may catalyze the oxidation of ammonia to form nitrogen dioxide. For example, the concentration of nitrogen monoxide and ammonia may be inferred in that firstly a gas analyzer measures the nitrogen dioxide concentration, then one catalytic converter catalyzes the oxidation of nitrogen monoxide to form nitrogen dioxide, subsequently another gas analyzer measures the resulting nitrogen dioxide concentration, another catalytic converter then catalyzes the oxidation of ammonia to form nitrogen dioxide, and finally still another gas analyzer measures the newly resulting nitrogen dioxide concentration.

Within the scope of another specific embodiment, the gas sensor therefore includes two or more different catalytic converters for catalyzing different reactions of first gas species to form second gas species and/or two or more different gas analyzers for spectroscopically measuring, for example, by absorption spectroscopy, fluorescence spectroscopy, vibrational spectroscopy, and/or diffraction spectroscopy, the concentrations of different second gas species.

Depending on the installation location of the sensor in the exhaust system, it may be necessary to keep the catalytic converter at a certain temperature. To be able to intentionally bring the catalytic converter to an optimal operating temperature, the gas sensor includes a catalytic converter heater.

To avoid or remove soiling and/or contamination, for example, by soot particles or chemically aggressive exhaust gas components on the optical components, such as the lenses, mirrors, or radiation-conducting fibers, of the gas analyzer, the gas sensor may also include an optics heater.

It may be particularly advantageous in this case to combine the catalytic converter heater and the optics heater with one another. The gas sensor may therefore in particular include a combined catalytic converter-optics heater.

In order to avoid soiling and/or contamination, for example, by soot particles, the gas sensor may also include a particle filter.

Within the scope of another specific embodiment, the gas sensor includes a gas-inlet-side particle filter. In particular, the particle filter may be the unit of the gas sensor which a gas first passes when flowing through the gas sensor. The particle filter may have a particle filter heater to free the particle filter from accumulated soot particles.

Within the scope of one embodiment, the particle filter is designed in the form of a replaceable unit. This has the advantage that the particle filter may be replaced easily. This may be advantageous in particular if ashes which cannot be removed by heating impair the function of the particle filter and possibly also the gas sensor itself over time.

Within the scope of another embodiment, the particle filter is designed in the form of a particle-filtering, gas-permeable gas inlet wall of a measuring cell. The catalytic converter may also be integrated into the gas inlet wall. This has the advantage, on the one hand, that the space requirement of the gas sensor may be minimized. On the other hand, the catalytic converter and the particle filter may use a shared catalytic converter-particle filter heater, which decreases the production costs of the gas sensor, on the one hand, and further minimizes the space requirement of the gas sensor, on the other hand.

An equilibrium set by the catalytic converter may be a function of the temperature and/or the oxygen partial pressure, for example. In the event of a low oxygen partial pressure, for example, the thermodynamic equilibrium: 2 NO+O₂⇄2 NO₂ may be shifted toward the side of nitrogen monoxide. Therefore, the gas sensor preferably also includes a lambda sensor and/or a chemosensitive field effect transistor and/or a temperature measuring device.

In particular, the gas sensor may include an evaluation circuit. The evaluation circuit is preferably situated in a colder area of the gas sensor which is remote from the measuring cell, which has an advantageous effect on the service life of the evaluation circuit.

The evaluation circuit may analyze the measuring results of the gas analyzers under consideration of other values, for example, the temperature, the oxygen concentration, etc. The other values may originate from sensor-internal units, such as a heater, a temperature measuring device, a lambda sensor, and/or a chemosensitive field effect transistor. Alternatively or additionally thereto, however, values of units of the internal combustion engine, such as the lambda sensor of the internal combustion engine, may also be used.

In order to protect the radiation source, the radiation detector, and the evaluation circuit from heat, the gas sensor may also have a thermal insulation. The measuring cell is preferably partially enclosed with thermal insulation.

The gas sensor is preferably designed in such a way that the flow rate of a gas species mixture flowing through the gas sensor is sufficiently low to ensure a complete conversion by the catalytic converters. For example, the flow rate of a gas species mixture flowing through the gas sensor may be in a ratio of 1:1000 to 1:100000 to the flow rate in the exhaust system of an internal combustion engine, in particular a motor vehicle.

A further object of the present invention is a method for ascertaining the concentration of one or more gas species, for example, nitrogen monoxide and nitrogen dioxide and possibly ammonia, in particular in the exhaust gas of an internal combustion engine, for example, an internal combustion engine of a motor vehicle, which includes the following method steps:

a) converting a first gas species into a second gas species, in particular in a catalysis area of a measuring cell by a catalytic converter; and

b) spectroscopically measuring, for example, by absorption spectroscopy, fluorescence spectroscopy, vibrational spectroscopy, and/or diffraction spectroscopy, the concentration of the second gas species, in particular by a gas analyzer in an analysis area of the measuring cell; and

c) ascertaining the concentration of the first gas species from the concentration of the second gas species measured in method step b), in particular by an evaluation circuit.

The method according to the present invention may be carried out using a gas sensor according to the present invention, for example.

The second gas species may possibly also at least partially be present before method step a). In this case, in method step b), a summation signal is measured from the second gas species concentration already present before method step a) and the second gas species concentration arising in method step a).

Within the scope of another specific embodiment, the method therefore includes the following method step before method step a):

a0) spectroscopically measuring, for example, by absorption spectroscopy, fluorescence spectroscopy, vibrational spectroscopy, and/or diffraction spectroscopy, the concentration of the second gas species, in particular by a further gas analyzer in a further analysis area of the measuring cell situated upstream from the catalysis area, the concentration of the first gas species being ascertained in method step c) from the concentration of the second gas species measured in method steps a0) and b).

In method step a), the first gas species may be oxidized or reduced to form the second gas species. The first gas species may be nitrogen monoxide or ammonia, for example. The second gas species may be nitrogen dioxide, for example.

The spectroscopic measurement may be based on the fact, for example, that the second gas species has radiation in the absorption and/or scattering wavelength range of the second gas species transmitted through it and the intensity of at least one absorption and/or scattering wavelength transmitted through the second gas species is measured.

After method step c), method steps a), b), c) and optionally a0) may be performed again once or multiple times to ascertain the concentration of other first gas species, another first gas species being converted to the same second gas species as in the preceding method step pass or into another second gas species in method step a).

In method step a), a different temperature may be set than in the preceding method step pass and/or a different catalytic converter may be used than in the preceding method step pass.

In method step b) and optionally method step a0), spectroscopic measurement may be carried out using a different absorption and/or scattering wavelength than in the preceding method step pass.

The conversion in method step a) may be a function, inter alia, of the temperature and/or the oxygen partial pressure.

Within the scope of one specific embodiment, the temperature and/or the oxygen partial pressure are therefore taken into consideration when ascertaining the concentration of the first gas species in method step c).

### BRIEF DESCRIPTION OF THE DRAWINGS

Further advantages and advantageous embodiments of the present invention are shown in the figures and explained below. It is to be noted that the figures are solely descriptive in nature and are not intended for the purpose of restricting the present invention in any form.

FIG. 1 shows a schematic cross section through a first specific embodiment of a gas sensor according to the present invention.

FIG. 2 shows a schematic cross section through a second specific embodiment of a gas sensor according to the present invention.

FIG. 3 shows a schematic cross section through a third specific embodiment of a gas sensor according to the present invention.

FIG. 4 shows a schematic cross section through a fourth specific embodiment of a gas sensor according to the present invention.

FIG. 5 shows a schematic cross section through a fifth specific embodiment of a gas sensor according to the present invention.

FIG. 6 shows a graph to illustrate the theoretical nitrogen monoxide-nitrogen dioxide ratio in the thermodynamic equilibrium.

### DETAILED DESCRIPTION OF EXAMPLE EMBODIMENTS

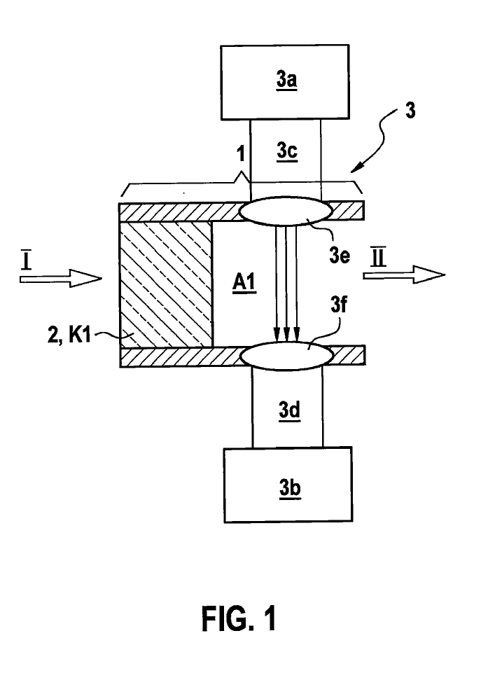

FIG. 1 shows that the gas sensor includes a measuring cell 1 having a gas inlet I, a gas outlet II, a catalysis area K1, and an analysis area A1, catalysis area K1 being situated on the gas inlet side of analysis area A1. FIG. 1 additionally shows that the gas sensor includes a catalytic converter 2, which is situated in catalysis area K1. This catalytic converter may catalyze the reaction of a first gas species to form a second gas species. Furthermore, FIG. 1 shows that the gas sensor includes a gas analyzer 3 for spectroscopically measuring the concentration of the second gas species in analysis area A1.

Gas analyzer 3 has a radiation source 3a and a radiation detector 3b. Radiation source 3a and the radiation detector are situated on opposing sides of measuring cell 1. The radiation emitted by radiation source 3a (illustrated by arrows) is transmitted through analysis area A1 and radiation detector 3b measures the intensity of at least one absorption and/or scattering wavelength of the second gas species transmitted through analysis area A1. Radiation source 3a may be at least one semiconductor radiation source. For example, radiation source 3a may include one or more semiconductor laser diodes and/or one or more light-emitting diodes (LED). To be able to transmit the radiation in bundled form into analysis area A1 and to be able to bundle it after being transmitted through analysis area A1, the gas analyzer also includes two converging lenses 3e, 3f. To protect radiation source 3a and the radiation detector from heat, they are situated remotely from the measuring cell and are connected in a radiation-conducting way to the converging lenses via radiation-conducting fibers, in particular glass fibers 3c, 3d.

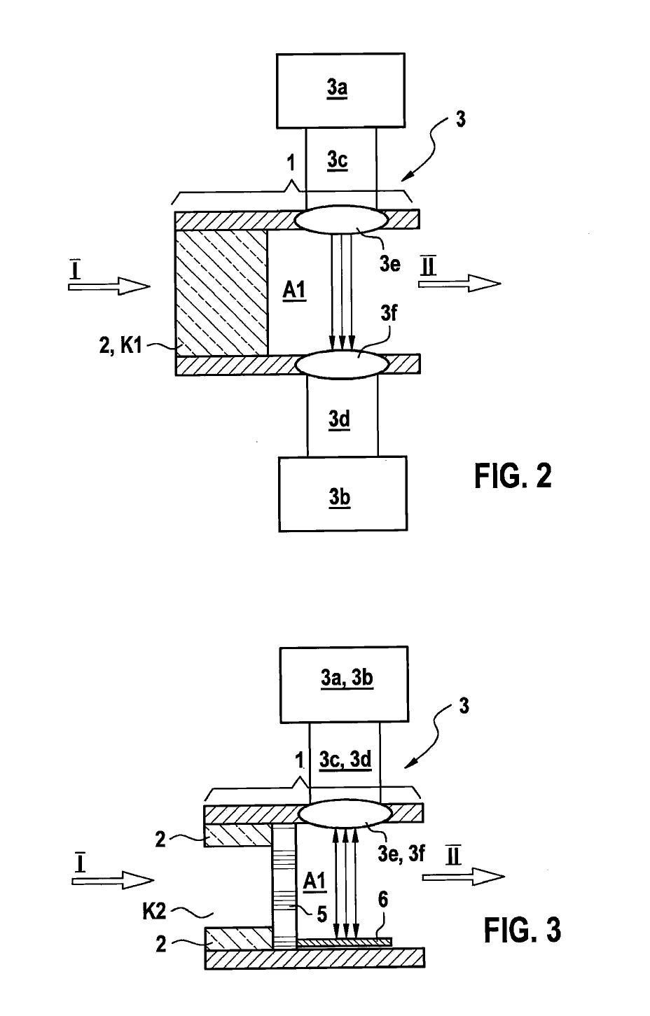

The second specific embodiment shown in FIG. 2 generally differs from the first specific embodiment shown in FIG. 1 in that catalytic converter 2 additionally fulfills a particle-filtering function and is designed in the form of a particle-filtering, gas-permeable gas inlet wall of measuring cell 1. This has the advantage that the space requirement of the gas sensor may be minimized. In addition, a common catalytic converter-particle filter heater may be used for the catalyzing and particle filtering.

The third specific embodiment shown in FIG. 3 generally differs from the first specific embodiment shown in FIG. 1 in that catalytic converter 2 is designed in the form of a coating on the inner side of measuring cell 1 in the catalysis area and, in order to avoid eddies between catalysis area K1 and analysis area A1, the gas sensor has a gas-permeable element 5, which subdivides measuring cell 1 into catalysis area K1 and analysis area A1. Furthermore, the third specific embodiment differs from the other shown specific embodiments in that the gas analyzer has a combined radiation source-radiation detector device 3a, 3b, which is situated on one side of measuring cell 1, measuring cell 1 having a radiation reflection layer 6. The radiation emitted by radiation source 3a (illustrated by arrows) is transmitted through analysis area A1, reflected by radiation reflection layer 6, and is again transmitted through analysis area A1 (illustrated by arrows), so that combined radiation source-radiation detector device 3a, 3b may measure the intensity of at least one absorption and/or scattering wavelength of the second gas species transmitted through analysis area A1.

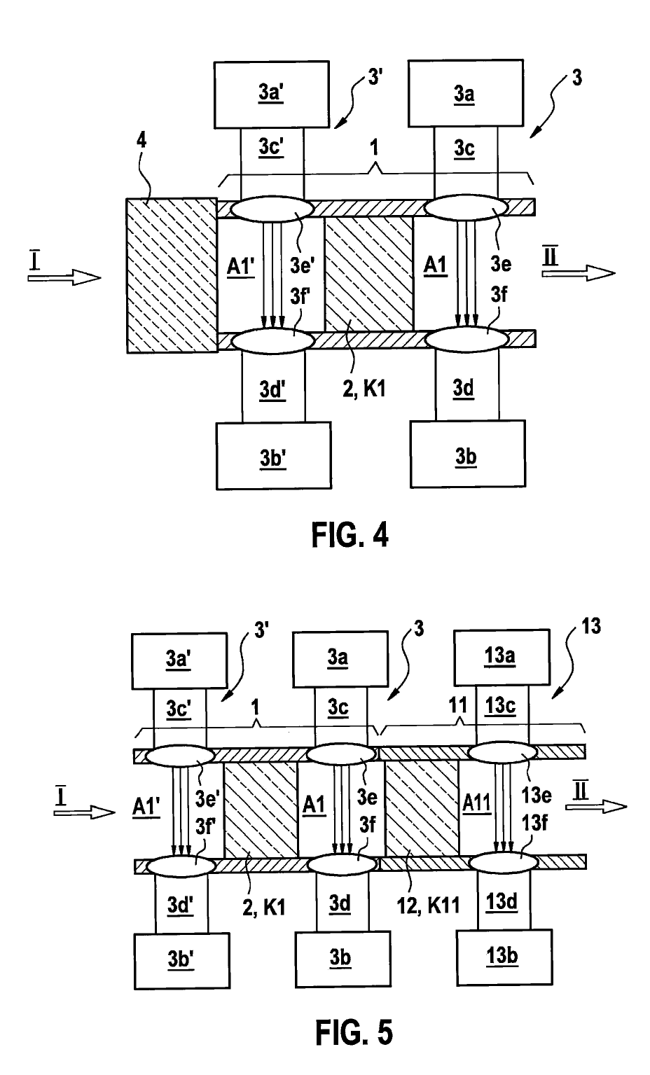

The fourth specific embodiment shown in FIG. 4 generally differs, on the one hand, from the first specific embodiment shown in FIG. 1 in that the gas sensor also has a particle filter 4 designed in the form of a replaceable unit, to avoid soiling and/or contamination, for example, by soot particles, of the catalytic converter and the optics, in particular lenses 3e, 3f of gas analyzer 3. The fourth specific embodiment shown in FIG. 4 generally differs, on the other hand, from the first specific embodiment shown in FIG. 1 in that measuring cell 1 includes a further analysis area A1′ situated upstream from catalysis area K1 and the gas sensor includes a further gas analyzer 3′ for spectroscopically measuring the concentration of the second gas species in further analysis area A1′. Further gas analyzer 3′ is designed similarly to the gas analyzer 3 described in conjunction with FIG. 1 and includes a radiation source 3a′, a radiation detector 3b′, two converging lenses 3e′, 3f′, and two radiation-conducting fibers 3c′, 3d′.

The fifth specific embodiment shown in FIG. 5 generally differs from the fourth specific embodiment shown in FIG. 4 in that the gas sensor includes a second catalytic converter 12, a second gas analyzer 13, and a second measuring cell 11. The second measuring cell includes, like first measuring cell 1, a gas inlet I, a gas outlet II, a catalysis area K11, and an analysis area A11, catalysis area K11 being situated on the gas inlet side of analysis area A11. Second catalytic converter 12 is a catalytic converter different from first catalytic converter 2.

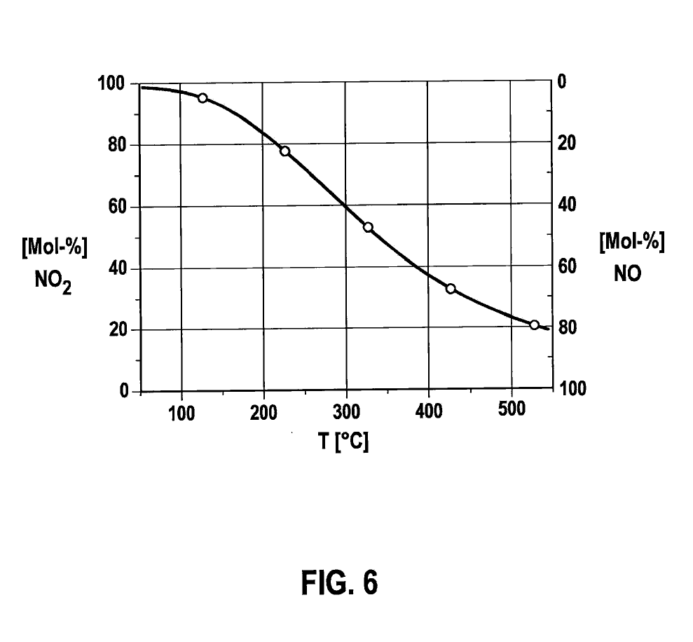

FIG. 6 illustrates the temperature dependence of the thermodynamic equilibrium of nitrogen monoxide and nitrogen dioxide. FIG. 6 shows that the thermodynamic equilibrium is shifted at high temperatures in favor of nitrogen dioxide. This fact may be utilized for the purpose of forcing a conversion of nitrogen monoxide as the first gas species into nitrogen dioxide as the second gas species.

1-12. (canceled)

13. A gas sensor for ascertaining a concentration of one or more gas species, comprising:
a measuring cell having a gas inlet, a gas outlet, a catalysis area, and an analysis area, the catalysis area being situated on a gas inlet side of the analysis area;
a catalytic converter to catalyze a reaction of a first gas species to form a second gas species in the catalysis area; and
a gas analyzer to spectroscopically measure the concentration of the second gas species in the analysis area.

14. The gas sensor as recited in claim 13, wherein the catalytic converter is an oxidation catalytic converter for oxidation of the first gas species to form the second gas species.

15. The gas sensor as recited in claim 13, wherein the gas sensor is configured to measure concentration of nitrogen monoxide, the catalytic converter being an oxidation catalytic converter for oxidation of nitrogen monoxide to form nitrogen dioxide.

16. The gas sensor as recited in claim 13, wherein the gas sensor is configured to measure concentration of ammonia, the catalytic converter being an oxidation catalytic converter for oxidation of ammonia to form nitrogen oxide.

17. The gas sensor as recited in claim 13, wherein the catalytic converter at least one of:
is integrated into a gas-permeable wall of the measuring cell;
is designed in the form of a coating on an inner side of the measuring cell; and
is designed in the form of a gas-permeable element which subdivides the measuring cell.

18. The gas sensor as recited in claim 13, wherein the gas sensor includes a further gas analyzer to spectroscopically measure concentration of the second gas species in a further analysis area of the measuring cell, the further analysis area being situated on the gas inlet side of the catalysis area.

19. The gas sensor as recited in claim 13, wherein the gas analyzer includes at least one semiconductor radiation source, the at least one semiconductor radiation source including at least one of a semiconductor laser diode, and a light-emitting diode.

20. The gas sensor as recited in claim 13, wherein the gas sensor includes at least two measuring cells, the measuring cells each having a gas inlet, a gas outlet, a catalysis area, and an analysis area, each of the catalysis areas being situated on the gas inlet side of the analysis area, and the gas sensor also including at least two catalytic converters to catalyze reactions of first gas species to form second gas species in one of the catalysis areas in each case and at least two gas analyzers to spectroscopically measure concentration of the second gas species in one of the analysis areas in each case.

21. The gas sensor as recited in claim 20, wherein the gas sensor includes at least two different catalytic converters for catalyzing different reactions of first gas species to form second gas species.

22. The gas sensor as recited in claim 20, wherein the gas sensor includes at least two different gas analyzers to spectroscopically measure concentrations of different second gas species.

23. The gas sensor as recited in claim 13, wherein the gas sensor includes a gas-inlet-side particle filter.

24. A method for ascertaining concentration of one or more gas species, comprising:
a) converting a first gas species into a second gas species;
b) spectroscopically measuring concentration of the second gas species; and
c) ascertaining concentration of the first gas species from the concentration of the second gas species measured in step b).

25. The method as recited in claim 24, wherein the method further comprises, before method step a):
a0) spectroscopically measuring the concentration of the second gas species;
wherein in method step c), the concentration of the first gas species is ascertained from the concentration of the second gas species measured in method steps a0) and b).

26. The method as recited in claim 24, wherein at least one of a temperature, and oxygen partial pressure, are taken into consideration when ascertaining the concentration of the first gas species in method step c).
